(19) United States
(12) Patent Application Publication
(10) Pub. No.: US 2005/0216910 A1
(43) Pub. Date: Sep. 29, 2005

(54) Increasing fault-tolerance and minimizing network bandwidth requirements in software installation modules

(76) Inventor: Benoit Marchand, Montreal (CA)

Correspondence Address: CARR & FERRELL LLP, 2200 GENG ROAD, PALO ALTO, CA, 94303, US

(21) Appl. No.: 11/067,458

(22) Filed: Feb. 24, 2005

Related U.S. Application Data
(63) Continuation-in-part of application No. 10/893,752, filed on Jul. 16, 2004.
Application No. 10/893,752 is a continuation-in-part of application No. 10/445,145, filed on May 23, 2003.
(60) Provisional application No. 60/548,503, filed on Feb. 26, 2004.
(60) Provisional application No. 60/488,129, filed on Jul. 16, 2003.

(30) Foreign Application Priority Data
May 23, 2002 (EP) 02011310.6

(51) Int. Cl. G06F 9/445

(52) U.S. Cl. 717/174

(57) ABSTRACT

Exemplary methods and apparatus for improving speed, scalability, robustness, and dynamism of software installation package data transfers and software installation modules on processing devices are provided. Software installation modules utilize a priori or on-demand transfer of sets of files or other data to remote processing devices for software installation to take place. The fully distributed data transfer and data replication protocol of the present invention permits transfers that minimize processing requirements on master transfer nodes by spreading work across the network and automatically synchronizing with software installation modules to perform software installation or update resulting in higher scalability, more dynamism, and allowing fault-tolerance by distribution of functionality as opposed to current methodologies. Data transfers occur persistently such that new nodes being added, or alternatively nodes recovering from a crash that occurred before or during the data transfer phase, will automatically and asynchronously proceed to complete the missed data transfer phase and perform the software installation or update as required.

### CROSS-REFERENCE TO RELATED APPLICATIONS

This application claims the priority benefit of U.S. Provisional Patent Application No. 60/548,503 filed Feb. 26, 2004; this application is also a continuation-in-part of U.S. patent application Ser. No. 10/893,752 filed Jul. 16, 2004 and entitled “Maximizing Processor Utilization and Minimizing Network Bandwidth Requirements in Throughput Compute Clusters,” which is a continuation-in-part of U.S. patent application No. 10/445,145 filed May 23, 2003 and entitled “Implementing a Scalable Dynamic, Fault-Tolerant, Multicast Based File Transfer and Asynchronous File Replication Protocol,” which claims the foreign priority benefit of European Patent Application Number 02011310.6 filed May 23, 2002 and now abandoned; U.S. patent application Ser. No. 10/893,752 also claims the priority benefit of provisional patent application number 60/488,129. The disclosures of all the aforementioned and commonly owned applications are incorporated herein by reference.

### BACKGROUND

1. Field of the Invention

The present invention relates, generally, to transferring and replicating software installation package data among geographically separated computing devices and synchronizing data transfers with software installation processing. The present invention also relates to autonomously and/or asynchronously maintaining replicated software installation package data, synchronizing software installation processing notwithstanding computing device failures, and introducing new computing devices into a network without user intervention.

2. Description of the Related Art

In order to install new software or update existing software into a network of computing devices, installation software package data must first be transferred to the devices where the software is to be installed.

The existing art, as it pertains to address installation software package data transfer and software installation synchronization, generally falls into four categories: (1) on-demand data transfer, (2) server-initiated point-to-point data transfer, (3) client-initiated point-to-point data transfer, and (4) server-initiated broadcast or multicast data transfer.

Software installation modules can make use of on-demand data and file transfer apparatus, better known as file servers, Network Attached Storage (NAS), and Storage Area Network (SAN). This type of solution works so long as a cluster size (i.e., number of remote processing devices where software is to be installed or updated) is limited in size due to issues related to support of connections, network capacity, high I/O demand, and transfer rate. This solution also requires manual intervention at each processing device in order to schedule software installation, to later verify that the installation completed successfully, and whenever new processing devices are introduced in a cluster. Synchronization of data transfer and software installation management is, however, implicit and requires no manual intervention.

Users or tasks can manually transfer software installation package data prior to software installation though a point-to-point file transfer protocol initiated from a central software installation server. Server-initiated point-to-point methods, however, impose severe loads on the network thereby limiting scalability. When server-initiated data transfers complete, synchronization with local software installation management facilities must be explicitly performed (e.g., an install command). Moreover, additional file transfers and software installation procedures must continually be initiated at the central server to cope with the constantly varying nature of large processing device networks (e.g., new devices being added to increase a cluster size or to replace failed or obsolete devices).

Users or tasks can manually transfer software installation package data prior to software installation through a point-to-point file transfer protocol initiated from the processing devices (e.g., clients) where software is to be installed or updated. Client-initiated point-to-point methods, however, also impose severe loads on the network thereby limiting scalability. When client initiated data transfers complete, the client-based software installation system typically may proceed without explicit synchronization being required. Additional file transfers and software installation procedures must continually be initiated at each client devices, however, to cope with the constantly varying nature of large computer networks (e.g., new nodes being added to increase a cluster or grid size or to replace failed or obsolete nodes).

Users or tasks can manually transfer software installation package data prior to installation though a server-initiated multicast or broadcast file transfer protocol. Multicast methods improve network bandwidth utilization over demand-based schemes as data is transferred “at once” over the network for all nodes. The final result, however, is the same as for server-initiated point-to-point methods: when data transfers are complete, synchronization with local software management facilities must be explicitly performed and additional file transfers must continually be initiated at the central server to cope with, for example, the constantly varying nature of large computer networks.

All four of these methods are based on synchronous data transfers. That is, software installation data for software package “A” is transferred contemporarily to package “A” being installed.

There is a need in the art to address the problem of replicated software installation data transfers and synchronizing with software management systems.

### SUMMARY OF THE INVENTION

Advantageously, the present invention implements a fully autonomous and asynchronous multicast data transfer system that continues operating through computer failures, allows data replication scalability to very large size networks, persists in transferring data to newly introduced nodes or recovering nodes even after the initial data transfer process has terminated, and synchronizes data transfer termination with software management utilities for installation operation.

The fully asynchronous nature of the present multicast data transfer is not found in prior art multicast data transfer system and apparatus. While the prior art may permit error recovery, it does so only while a data transfer is in progress. The present system and method supports error recovery after data transfers are complete. Thus, a single module may support mid-transfer, post-transfer, and even new node introduction in a seamless manner.

The present invention also seeks to ensure the correct synchronization of software installation data transfer and software installation function within a network of processing devices used for any data processing/transfer/display activity.

Further, the present invention includes automatic synchronization of software installation data transfer and software installation functions; data transfers for software packages to be installed occurring asynchronously to other unrelated software installation procedures; introducing new nodes and/or recovering disconnected and failed nodes; automatically recovering missed data transfers and synchronizing with software management functions; seamless integration of data distribution with any software installation method; seamless integration of dedicated clusters, edge grids, and generally processing devices (e.g., loosely coupled networks of computers, desktops, appliances, and nodes); and seamless deployment of software on any type of processing device concurrently.

The system and method according to embodiments of the present invention improve the speed, scalability, robustness, and dynamism of throughput cluster, edge grid processing applications, and general processing device operation. The asynchronous method used in the present invention transfers data before its use while processing devices are utilized for other functions. The ability to operate persistently through failures and processing device additions and removals enhances the robustness and dynamism of operation.

In accordance with one embodiment, the system and method improve speed, scalability, robustness, and dynamism of software installation modules. Computer system management, such as operating system update or installation, can benefit from a priori transfer of sets of software package data files or other data to remote computers prior to installation taking place.

Exemplary embodiments automate operations such as software installation across networks of processing devices, device introduction, or device recovery that might otherwise require manual intervention. Through automation, optimum processing utilization may be attained through reduced down time in addition to a lowering of network bandwidth utilization. Automation also reduces the cost of operating labor.

### BRIEF DESCRIPTION OF THE DRAWINGS

FIG. 1 illustrates an exemplary system for asynchronous software package data distribution and subsequent installation wherein software installation triggering is a purpose-built feature of the system.

FIG. 2 illustrates an exemplary system for asynchronous software package data distribution and subsequent installation wherein software installation triggering is performed through a job distribution workload management module.

FIG. 3 illustrates an exemplary method of asynchronous software package data distribution and subsequent installation of a single software package at a time utilizing either a built-in or a third-party software installation module.

FIG. 4 illustrates an exemplary method for asynchronous software package data distribution and subsequent installation of potentially multiple software packages at a time utilizing either a built-in or a third-party software installation module.

FIG. 5 illustrates an exemplary method for asynchronous software package data distribution and subsequent installation of potentially multiple software packages at a time utilizing a meta-language user interface and either a built-in or a third-party software installation module.

FIG. 6 illustrates an exemplary method for asynchronous software package data distribution and subsequent installation of potentially multiple packages at a time utilizing a job distribution meta-language user interface, and either a built-in or a third-party software installation module.

FIG. 7 illustrates an example of processing device membership description language syntax.

FIG. 8 illustrates an example of a list of software installation package modules.

FIG. 9 illustrates an example of software installation meta-language syntax.

FIG. 10 illustrates an example of job description meta-language syntax, normally used for distributing user jobs unto a network of processing devices but, in the present context, used to perform software installation.

### DETAILED DESCRIPTION OF AN EXEMPLARY EMBODIMENT

The terms “computer,” “node,” and “processing device,” as used in the description of the present invention, are to be understood in the broadest sense as they can include any computing device or electronic appliance including, for example, a personal computer, an interactive or cable television terminal, a cellular phone, or a PDA, all of which can be connected to various types of networks.

The term “data transfer,” as used in the description of the present invention, is also to be understood in the broadest sense as it can include full and partial data transfers. That is, a data transfer relates to transfers where an entire data entity (e.g., file) is transferred “at once” as well as situations where selected segments of a data entity are transferred at some point. An example of the latter case is a data entity being transferred in its entirety and, at a later time, selected segments of the data entity are updated.

The term “purpose-built module” as used in the description of the present invention, is also to be understood in the broadest sense. More specifically, however, a purpose-built module is a module, whether built-in or externally supplied, whose primary purpose is to perform software installation. Generally, there are two modules types one can utilize to perform software installation: the aforementioned purpose-built module and a ‘piggy back’ type module. The latter module is exemplified by a user of a job-dispatch module, that is, an unrelated module utilized to perform software installation. Furthermore, a built-in module may be a job-dispatch module or a purpose-built module. An external module may, too, be a job-dispatch module (non-purpose-built) or a third-party software installation tool (purpose-built).

The terms “software management utility” and “software installation module,” as used in the description of the present invention, are to be understood in the broadest sense as they can include any form of processing device software update, upgrade, installation, or management.

The terms “workload management utility,” “job distribution module,” and “workload distribution module,” as used in the description of the present invention, are to be understood in the broadest sense as they can include any form of remote processing module used to distribute processing among a network of nodes.

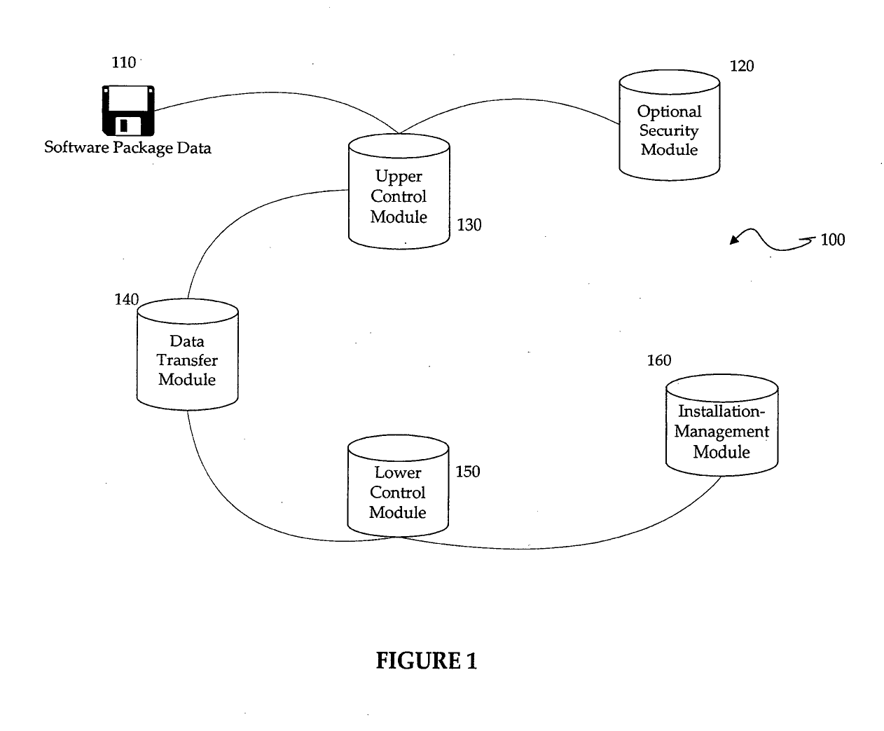

FIG. 1 illustrates an exemplary system 100 for asynchronous software package data distribution and subsequent installation; for example, when software installation is performed using a purpose-built module. The present embodiment corresponds to operating system installation on computers, for instance, the installation of Linux “RPM” modules on a computer. An upper control module 130 and a lower control module 150, together, embody a built-in software installation module. In one embodiment of the built-in software installation module, a call to the Linux “install” command is made from the lower control module 150. Alternatively, an optional third-party software installation module can be used.

It should be noted that FIG. 1 shows only whole modules and not super- or sub-components of those modules. Therefore, the built-in software installation module is not shown, and this system diagram is representative of any software installation embodiment, such as, but not limited to, single package installation, multiple package installation with a list of target packages, and multiple package installation using a meta-language user interface.

The built-in software installation module may, for example, be a sub-component of lower control module 150. Lower control module 150, however, may also call in an external module. FIG. 1 should be interpreted as illustrating where modules may reside and communicate and not, necessarily, how modules function internally. There are, at least, two possible types of modules to perform software installation: a built-in software installer and an external software installer. In an embodiment of the present invention, a built-in installer can be integrated with lower control module 150 whereas an external software installer may comprise utility 160.

Users submit installation package data 110 as a part of an overall software package to the upper control module 130 of the system 100. User credentials, permissions, and package applicability are checked by an optional security module 120. In one embodiment of the present invention, installation package data 110 comprises an installable software module, for instance, a Linux “RPM” file.

The security module 120, in one embodiment of the present invention, may be a check on a requesting user's permission to perform software installation on various target systems, and may be a validation of an apropos of installing the requested software package on the target systems. In some embodiments, the security module 120 may be a part of the upper control module 130.

The upper control module 130 then orders transfer of all required files by invoking a broadcast/multicast data transfer module 140. The transfer module 140 comprises a multicast data transfer module, which operates fully asynchronously (i.e., data transfer and error recovery phases need not occur contemporaneously). Files are then transferred to target processing devices.

Upon completion of said transfers, the lower control module 150, which is running on the processing devices, automatically synchronizes with a local software installation/management module 160 to initiate software update/upgrade/installation.

It should be noted that the upper control module 130 and lower control module 150 of FIG. 1 may act not only as a built-in software installation utility but also as a synchronizer with optional external software installation modules. Additionally, the synchronization enables the installation of software packages in a processing device that has a complete set of software package data.

It should be noted that software installation may occur asynchronously of data transfers to the extent that the lower control module 150 of FIG. 1 is capable of simultaneously processing software package data transfers for future software installations while synchronizing or installing software packages for a current software installation.

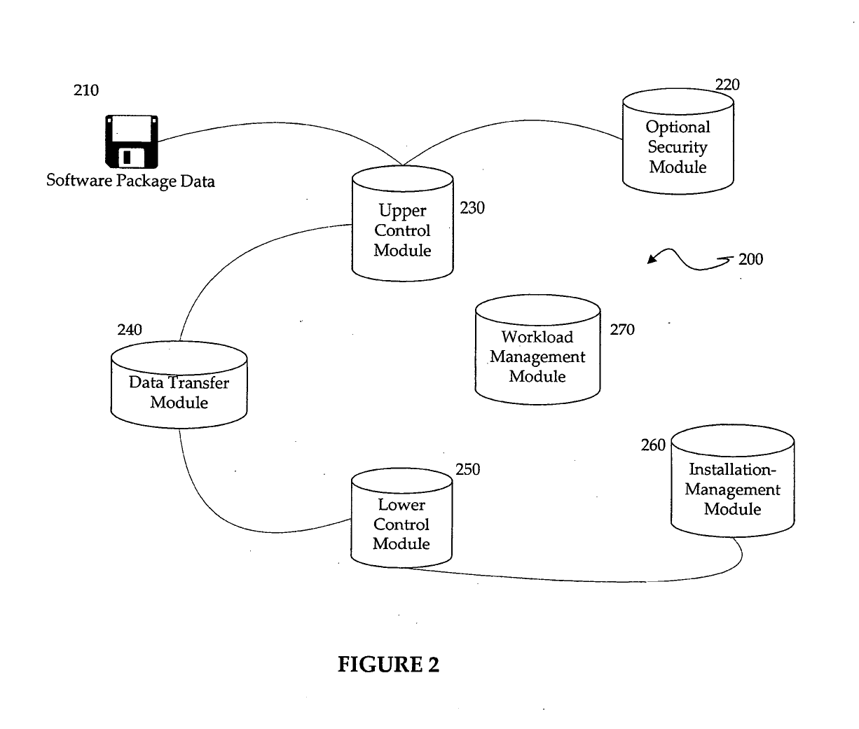

FIG. 2 illustrates an exemplary system 200 for asynchronous software package data distribution and subsequent installation utilizing a job-distribution workload management module 270. For example, a job-distribution workload management module 270 is used to trigger software installation wherein the purpose-built module of FIG. 1 might be replaced. One possible embodiment of the job-distribution workload management module 270 is described in related U.S. patent application Ser. No. 10/893,752. The interactions between the modules are as described in FIG. 1, except that a workload management module 270 is present although not necessarily used for user jobs distribution.

The workload management module 270's presence is a consequence of the utilization of a job submission meta-language being used to describe software installations (e.g., data and procedures). Because an embodiment of the present invention may use the capacity of the workload management module 270 to perform pre- and post-task distribution procedures, which may include software installation, that does not necessarily imply the required utilization of this function.

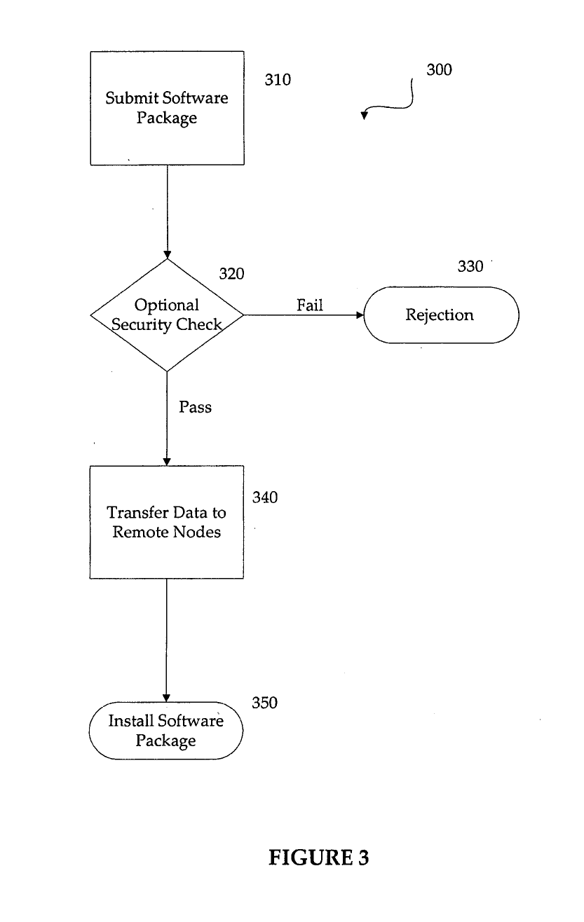

FIG. 3 illustrates an exemplary control flowchart 300 of a system like that shown in FIG. 1 when using a purpose-built module to execute software installation processes. More specifically, in the present embodiment, the completion of the transfer phase for a software package data file results in its immediate installation.

Users submit software package data 110 (FIG. 1) to be installed in the form of files step 310. An optional security check, in step 320, then determines if user credentials allow such an operation and whether the package should be allowed to be installed on the target processing devices. Software installation requests may be rejected in step 330 as a result of the security check in step 320 or allowed to proceed and ultimately result in the transfer of data to target processing devices in step 340. Once fully received, the software package is then installed in step 350.

It should be noted that security checks are implementation dependant and relate to situation/configuration/management specific requirements. For instance, in one embodiment of the present invention, security checks may validate the requesting user's permission to perform software installation on the target systems as well as validating the apropos of installing a specific software package on target systems.

It should also be noted that software installation may occur concurrently with other independent software package data transfers and installations. That is, in one embodiment, multiple packages may be set for installation independently of one another. In such a case, it is conceivable that one instance of software installation for package “A” may coexist with another instance of software installation for package “B” while one instance of data transfer for package “C” is active and another instance of data transfer for package “D” is running and so forth.

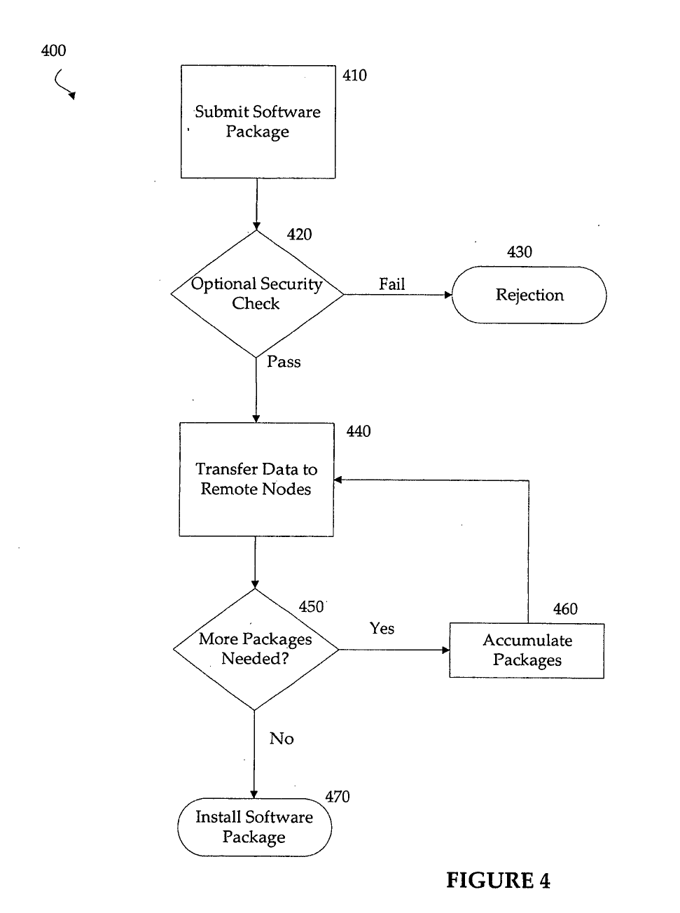

FIG. 4 illustrates an exemplary control flowchart 400 of a system like that shown in FIG. 1 when using a purpose-built module to execute software installation processes. More specifically, in the present embodiment, the completion of the transfer phase for all required software package data files 110 (FIG. 1) and a list of such files triggers the installation process. The process of FIG. 4 differs from that of FIG. 3. While FIG. 3 illustrates a method for single package installation, FIG. 4 illustrates a method wherein a list and/or series of packages are to be installed.

Users submit a list of software package names to be installed in step 410. An optional security check in step 420 determines if user credentials allow such an operation and whether the packages should be allowed to be installed on the target processing devices. Software installation requests may be rejected in step 430 or allowed to proceed and ultimately result in the transfer of the list and software installation data to target processing devices in step 440. Software package data files are accumulated in step 460 until all packages listed and necessary to trigger installation have been fully received in step 450. Once all necessary packages have been accumulated, the installation process is triggered in step 470.

It should be noted that security checks are implementation dependant and relate to situation/configuration/management specific requirements. It should also be noted that software installation may occur concurrently with other independent software package data transfers and installations.

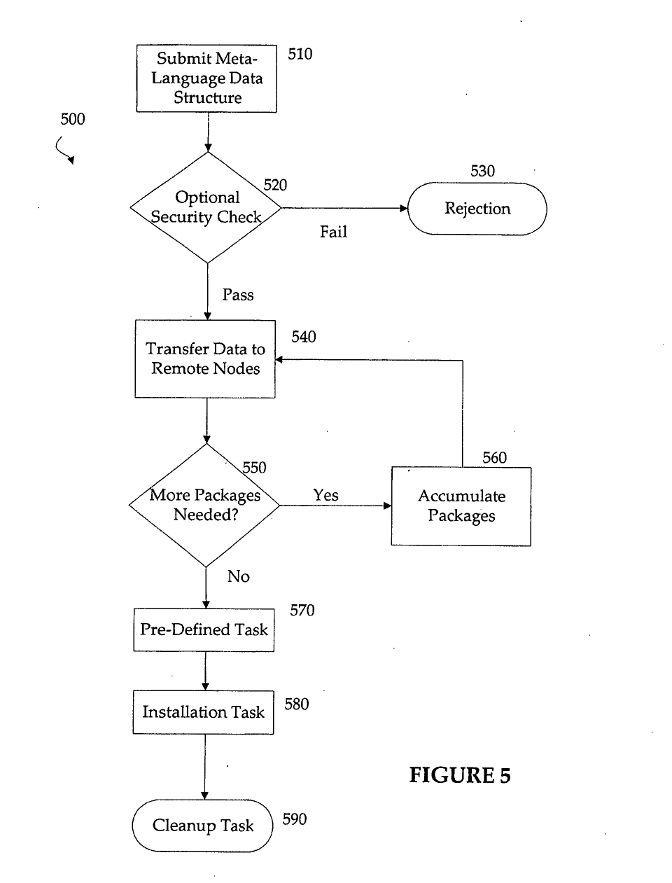

FIG. 5 illustrates an exemplary control flowchart 500 of a system like that shown in FIG. 1 when using a purpose-built module to execute software installation processes. More specifically, in the present embodiment, the completion of the transfer phase for all required software package data files and a meta-language data structure triggers the installation process.

Users submit a software installation meta-language data structure in step 510, which describes the software packages to be installed as well as the installation procedure. An optional security check in step 520 determines if user credentials allow such an operation and whether the packages should be allowed to be installed on the target processing devices. Software installation requests may be rejected in step 530 or allowed to proceed and ultimately result in the transfer of the meta-language data structure and software installation data to target processing devices in step 540.

Software package data files 110 (FIG. 1) are accumulated in step 560 until all packages listed in the software installation data structure and necessary to trigger installation have been fully received in step 550.

Following accumulation, an optional predefined task is executed in step 570, followed by the installation task in step 580, and subsequently by the execution of an optional cleanup task in step 590.

The predefined task in step 570 comprises a user-defined procedure meant to be executed prior to software installation taking place. Similarly, a cleanup task as in step 590 is a user-defined procedure meant to be executed after software installation completes.

It should be noted that security checks are implementation dependants and relate to situation/configuration/management specific requirements. It should also be noted that software installation may occur concurrently with other independent software package data transfers and installations.

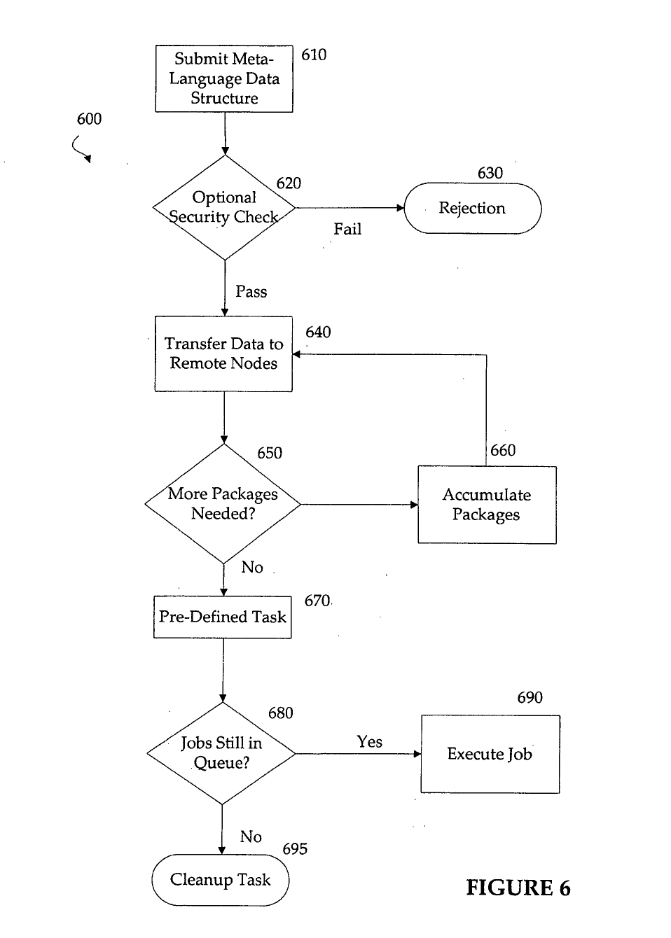

FIG. 6 illustrates an exemplary control flowchart 600 of a system like that shown in FIG. 2 when using a job-distribution module executes and trigger the software installation process.

Users submit a job description meta-language data structure in step 610, which describes the packages to be installed as well as the installation procedure using the facilities provided by a workload management module 270 (FIG. 2). An optional security check in step 620 determines if user credentials allow such an operation and whether the packages should be allowed to be installed on the target processing devices. Software installation requests may be rejected in step 630 or allowed to proceed and ultimately result in the transfer of the job description meta-language data structure and software installation data to target processing devices in step 640. Software package data files are accumulated in step 660 until all packages listed and necessary for triggering installation have been fully received in step 650. A predefined task may then be executed in step 670.

The workload distribution module 270 checks for possible jobs to be executed, as described in the meta-language data structure, in step 680, and, if there are, jobs are executed in step 690 until the job queue is empty. Finally, an optional cleanup task may be executed in step 695.

When a job-dispatch module is used for the purpose of software installation, the module may not be expected to be used to execute user jobs. Still, provisions may exist in the module such that job-dispatch events may not be excluded. Indeed, the use of a job dispatch module may be intended for substituting to a purpose-built software installation triggering module. In the present embodiment, it is the triggering capacity of the job-dispatch module which is of interest, not its ability to actually execute user jobs.

It should be noted that security checks are implementation dependants and relate to situation/configuration/management specific requirements. It should also be noted that software installation may occur concurrently with other independent software package data transfers and installations. Further, it should be noted that the workload management module may be internal or external to the system as exemplified in FIG. 2.

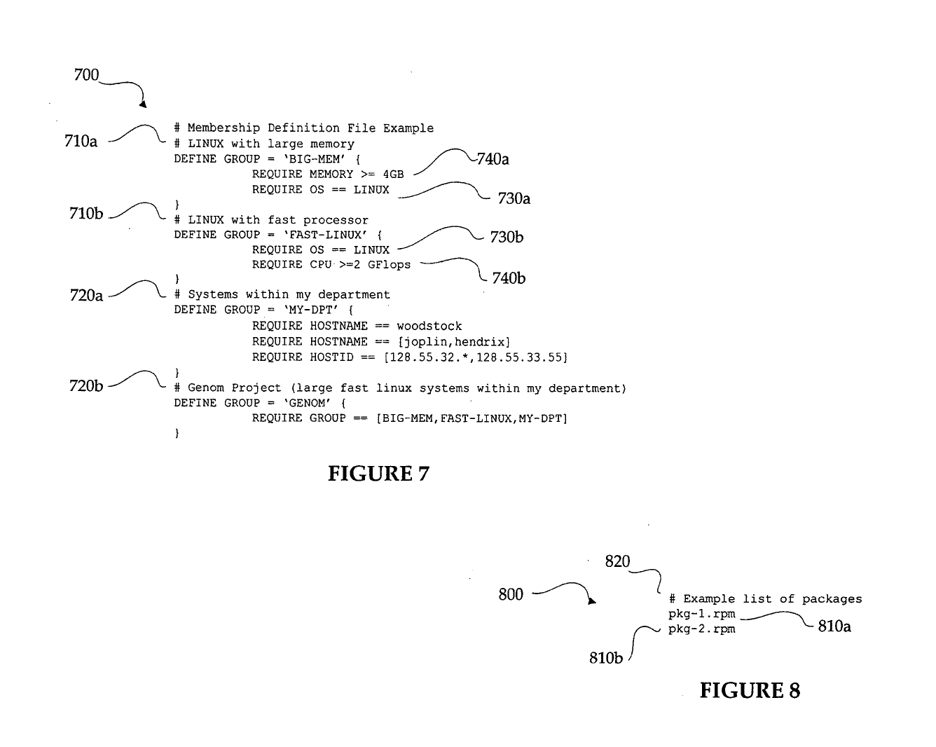

FIG. 7 is an example of an optional processing device group membership description file 700. The group membership file 700 allows for a logical association of processing devices with common characteristics, be they physical or logical. For instance, groups can be defined by series of physical characteristics 710a, 710b (e.g., processor type, operating system type, memory size, disk size, network mask) or logical 720a, 720b (e.g., systems belonging to a previously defined group membership). For example, through the use of group membership, sets of computers (i.e., devices) may be selected logically or physically whereby a system administrator may elect to install “Solitaire” on the desktops of administrators but not on the desktops of partners or associates.

Group membership is a module by which processing nodes may be targeted to participate in a software installation process. Group membership is a feature inherent to the underlying file broadcast/multicast module as described in U.S. patent application Ser. No. 10/893,752.

Membership may also be defined with specific characteristics 730a, 730b or ranges of characteristics 740a, 740b. Discrete characteristics are, for instance, “REQUIRE OS=LINUX” and ranges can be either defined by relational operators (e.g., “<”; “>” or “=”) or by a wildcard symbol (such as “*”). For example, the membership characteristic “REQUIRE HOSTID=128.55.32.*” implies all processing devices on the 128.55.32 sub-network have a positive match against this characteristic.

FIG. 8 is an example list 800 of software packages data structures. A list of software packages data structure (c.f., system FIG. 1 and method FIG. 4) is used to permit the installation of more than one software package at a time. The exact format of the list is variable. Software packages to be installed are listed one per line (810a, 810b). Lines beginning with a “#” sign are treated as comments (820).

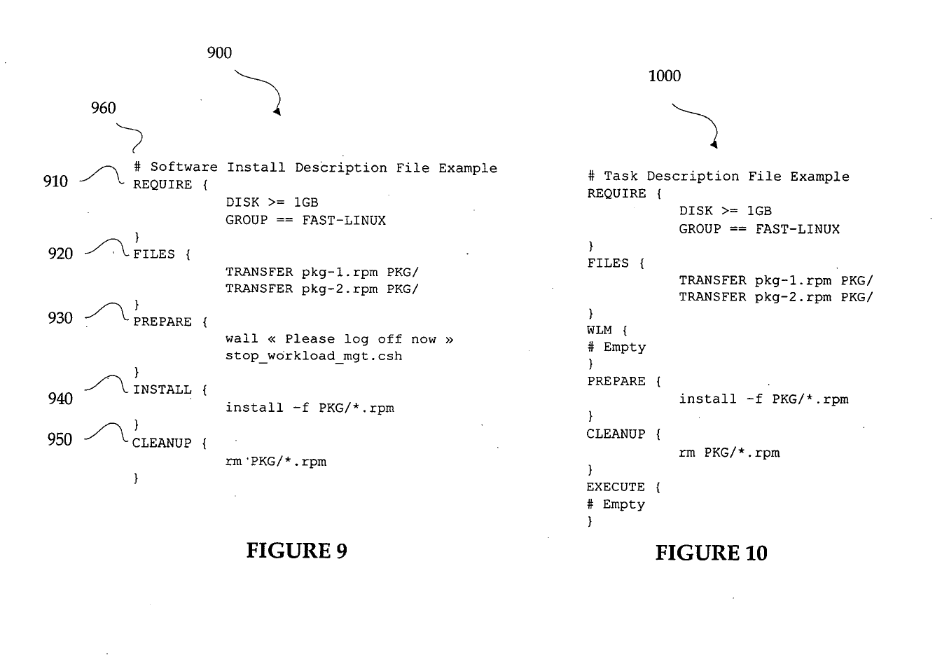

FIG. 9 is an example meta-language data structure 900 used to describe which software packages ought to be installed and how the installation process ought to be conducted. The exact format and meta-language of the data structure is variable. Lines beginning with a “#” sign are treated as comments 960.

Segregation on physical characteristics or logical membership may be determined by a REQUIRE clause 910. REQUIRE clause 910 lists each physical or logical match required for any processing device to participate in software installation activities.

A FILES clause 920 identifies which files are required to be available at all participating processing devices prior to software installation taking place. Files may be linked, copied from other groups, or transferred. In exemplary embodiments, actual transfer will occur only if the required file, or segments thereof, has not been transferred already in order to eliminate redundant data transfers.

A PREPARE clause 930 may be defined to describe how to prepare a system for software installation. Shell commands or command file names may be utilized. For instance, logged-on users may be forced to terminate or running applications may be check-pointed.

An INSTALL clause 940 describes how to perform the actual software installation. Shell commands or command file names may be utilized. For example, an “install” command may be defined.

A CLEANUP clause 950 describes how to complete a software installation procedure. Shell commands or command file names may be utilized. For example, a command to remove temporary files created during the installation process may be defined as part of a CLEANUP clause 950.

The FILES 920, PREPARE 930, INSTALL 940, and CLEANUP 950 clauses are based on a language, which includes built-in functions, such as conditional and iterative constructs (e.g., IF-THEN-ELSE, FOR-LOOP, etc.).

FIG. 10 is an example of a meta-language data structure 1000 used to describe which software packages ought to be installed and how the installation process should be conducted using the meta-language facilities of workload management modules. The exact format and meta-language of the data structure is variable. The meta-language is described in U.S. patent application Ser. No. 10/893,752. The meta-language data structure 1000's operation and use is similar to that of the meta-language module presented in FIG. 9.

A combination of persistent sessionless requests and distributed selection procedure allows for scalability and fault-tolerance since there is no need for global state knowledge to be maintained by a centralized entity or replicated entities. Furthermore, the sessionless requests and distributed selection procedure allows for a light-weight protocol that can be implemented efficiently even on appliance type devices. For the sake of clarity, it is noted that the terminology ‘sessionless’ means a communications protocol where an application layer module need not be aware of its peer(s) presence to operate. The term sessionless is not meant to be interpreted as the absence of the fifth layer of the ISO/OSI reference model that handles the details that must be agreed upon by two communicating devices.

The use of multicast or broadcast minimizes network utilization, allowing higher aggregate data transfer rates and enabling the use of lesser expensive networking equipment, which, in turn, allows the use of lesser expensive processing devices. The separation of multicast file transfer and recovery file transfer phases allows the deployment of a distributed file recovery module that further enhances scalability and fault-tolerance properties.

Finally, a file transfer recovery module can be used to implement an asynchronous file replication apparatus, where newly introduced processing devices or rebooted processing devices can perform data transfers which occurred while they were non-operational and after the completion of the multicast file transfer phase.

Activity logs may, optionally, be maintained for data transfers and software installation processing. Activity logs, in one embodiment of the present invention, may register which user installed which packages on which systems and at what times. Activity logs may also be maintained with regard to the completion status for requested software installations for each participating system.

Activity logs, further, may be maintained with regard to deltas in data transmissions. For example, if an event during data transfer causes the interruption of the transfer (e.g., the failure of a node or a total system shutdown or crash), delta data in the activity log may allow for the data transmission to re-commence where it was interrupted rather than requiring the entire retransmission and installation of software package data, including overwriting of already present or already installed data.

In one embodiment, the present invention is applied to file transfer and file replication and synchronization with software installation function. One skilled in the art will, however, recognize that the present invention can be applied to the transfer, replication, and/or streaming of any type of data applied to any type of processing device and any type of software installation module.

Detailed descriptions of exemplary embodiments are provided herein. It is to be understood, however, that the present invention may be embodied in various forms. Therefore, specific details disclosed herein are not to be interpreted as limiting, but rather as a basis for claims and as a representative basis for teaching one skilled in the art to employ the present invention in virtually any appropriately detailed system, structure, method, process, or manner.

1. A software installation method, comprising:
providing a network of devices;
providing software package data for installation on at least one of the devices;
transferring the software package data to the at least one of the devices wherein the transfer is fully asynchronous and autonomous; and
installing the transferred software package data on the at least one of the devices wherein the installation is triggered by the completion of the transfer of all software package data necessary to perform the installation.

2. The method of claim 1, further comprising introducing a device to the network of devices after competition of the transfer of the software package data.

3. The method of claim 1, further comprising determining if user credentials allow for installation of the transferred software package data on the at least one of the devices.

4. The method of claim 3, wherein the user credentials comprise situation dependent requirements.

5. The method of claim 3, wherein the user credentials comprise configuration dependent requirements.

6. The method of claim 3, wherein the user credentials comprise management dependent requirements.

7. The method of claim 1, wherein the software package data comprises a membership description file.

8. The method of claim 7, wherein the membership description file associates devices with common characteristics.

9. The method of claim 8, wherein the common characteristics comprise logical characteristics.

10. The method of claim 8, wherein the common characteristics comprise physical characteristics.

11. The method of claim 8, wherein the common characteristics comprise specific characteristics.

12. The method of claim 8, wherein the common characteristics comprise ranges of characteristics.

13. The method of claim 1, wherein the software package data comprises meta-language data structure.

14. The method of claim 13, where the meta-language data structure comprises a REQUIRE clause.

15. The method of claim 13, where the meta-language data structure comprises a FILES. clause.

16. The method of claim 13, where the meta-language data structure comprises a PREPARE clause.

17. The method of claim 13, where the meta-language data structure comprises an INSTALL clause.

18. The method of claim 13, where the meta-language data structure comprises a CLEANUP clause.

19. The method of claim 1, wherein installation occurs concurrently with at least one additional software package data transfer operating concurrently with at least one additional software installation module.

20. The method of claim 1, wherein the transfer comprises a multicast protocol.

21. The method of claim 1, wherein the transfer comprises a broadcast protocol.

22. The method of claim 1, wherein the network of devices comprises a personal computer.

23. The method of claim 1, wherein the network of devices comprises a television terminal.

24. The method of claim 1, wherein the network of devices comprises a cellular phone.

25. The method of claim 1, wherein the network of devices comprises a PDA.
